(19) United States
(12) Patent Application Publication
(10) Pub. No.: US 2003/0050103 A1
(43) Pub. Date: Mar. 13, 2003

(54) Power management scheme for a communication interface of a wireless device

(76) Inventors: Jean Tourrilhes, Mountain View, CA (US); Venkatesh Krishnan, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/949,451

(22) Filed: Sep. 7, 2001

(51) Int. Cl. H04M 1/00

(52) U.S. Cl. 455/574; 455/572

(57) ABSTRACT

A system for managing power consumption of a first communication interface of a device that communicates with an external wireless network is described. The system includes a power activator external to the device to send a power-up trigger signal to the device when the external wireless network needs to communicate with the device via the first communication interface. A second communication interface is located inside the device to receive the power-up trigger signal from the power activator. A power management module is located inside the device and is coupled to the first and second communication interfaces to cause the first communication interface (1) to power off when the power management module determines that the first communication interface is no longer needed and (2) to power up when the power management module receives the power-up trigger signal from the second communication interface. A method for managing power consumption of a first communication interface of a device that communicates with an external wireless network is also described.

### BACKGROUND OF THE INVENTION

1. Field of the Invention

The present invention pertains to wireless network communication. More particularly, this invention relates to a power management scheme for a communication interface of a wireless mobile device.

2. Description of the Related Art

Different wireless networks offer different characteristics. Local wireless communication links can be used to reach locally connected devices and/or systems. Wireless communication links can also be used to reach local infrastructures. A device with more than one wireless link can exploit this diversity by selecting the current best link for the specific network transaction it needs to perform. A common example of such a device is a cellular phone that includes support for Analog Modulation Phone System (AMPS) and Digital Modulation Phone System (DAMPS). The switching between the two systems depends on coverage. Another example is a portable computer that is equipped with an IrDA interface (i.e., directional infrared), a local radio network interface, and a long range cellular phone network interface.

As is known, power consumption is an important factor in mobile devices. Also, most wireless links consume a fair amount of power when in use. This means that some power saving mechanisms are needed. However, existing power saving schemes for wireless systems are typically based on a simple technique. According to that simple technique, when the wireless system detects that its wireless link interface is inactive, the interface is powered off to conserve power. In most cases, the interface is then switched on periodically for a short period of time to check if there is any request for any activity. If no such a request is detected, the interface is typically powered off again immediately.

One disadvantage of these prior art schemes is that they tend to increase connection latency between any two devices or systems. Connection latency is from the time at which a wireless system is requesting the connection with another system until the time at which the requesting wireless system is connected to the other wireless system. This means that if a wireless system is equipped with such a power conservation mechanism and a connection request is made to the wireless system, the connection request will only be handled by the wireless system after the wireless system is powered up again from its power-off state. This typically increases the connection latency.

Thus, there exists a need to create a power conservation scheme for a wireless system while minimizing the connection latency of the wireless system. This in turn will allow improve user experience in a mobile wireless communication environment.

### SUMMARY OF THE INVENTION

One feature of the present invention is to minimize power consumption of a mobile device.

Another feature of the present invention is to reduce connection latency of a mobile device while minimizing power consumption of the device.

A further feature of the present invention is to improve user experience in a mobile wireless communication environment.

A system for managing power consumption of a first communication interface of a device that communicates with an external wireless network includes a power activator external to the device to send a power-up trigger signal to the device when the external wireless network needs to communicate with the device via the first communication interface. A second communication interface is located inside the device to receive the power-up trigger signal from the power activator. A power management module is located inside the device and is coupled to the first and second communication interfaces to cause the first communication interface (1) to power off when the power management module determines that the first communication interface is no longer needed and (2) to power up when the power management module receives the power-up trigger signal from the second communication interface.

A method for managing power consumption of a first communication interface of a device that communicates with an external wireless network is also described. The method includes a step of generating a power-up trigger signal from a power activator external to the device when the external wireless network needs to communicate with the device via the first communication interface. The power-up trigger signal is then received by a second communication interface inside the device. The first communication interface is then caused (1) to power off when a power management module determines that the first communication interface is no longer needed and (2) to power up when the power management module receives the power-up trigger signal from the second communication interface.

Other features and advantages of the invention will become apparent from the following detailed description, taken in conjunction with the accompanying drawings, illustrating by way of example the principles of the invention.

### BRIEF DESCRIPTION OF THE DRAWINGS

FIG. 1 shows a wireless communication network system in accordance with prior art.

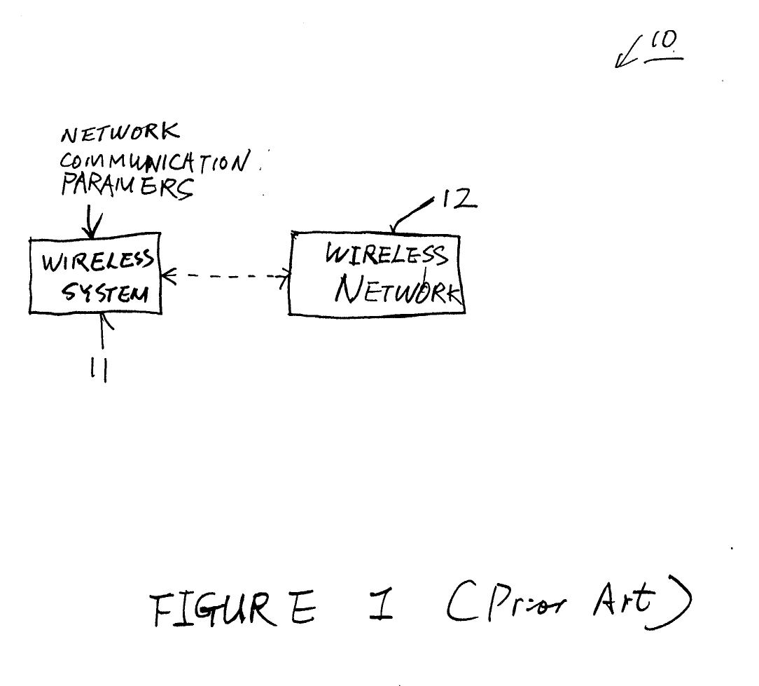

FIG. 2 schematically shows a power management system that manages power consumption a communication or network interface of a device in accordance with one embodiment of the present invention.

FIG. 3 shows in flow chart diagram form the process of the power management module of the power management system of FIG. 2.

FIG. 4 shows in flow chart diagram form the process of the second network interface of the power management system of FIG. 2.

### DETAILED DESCRIPTION OF THE INVENTION

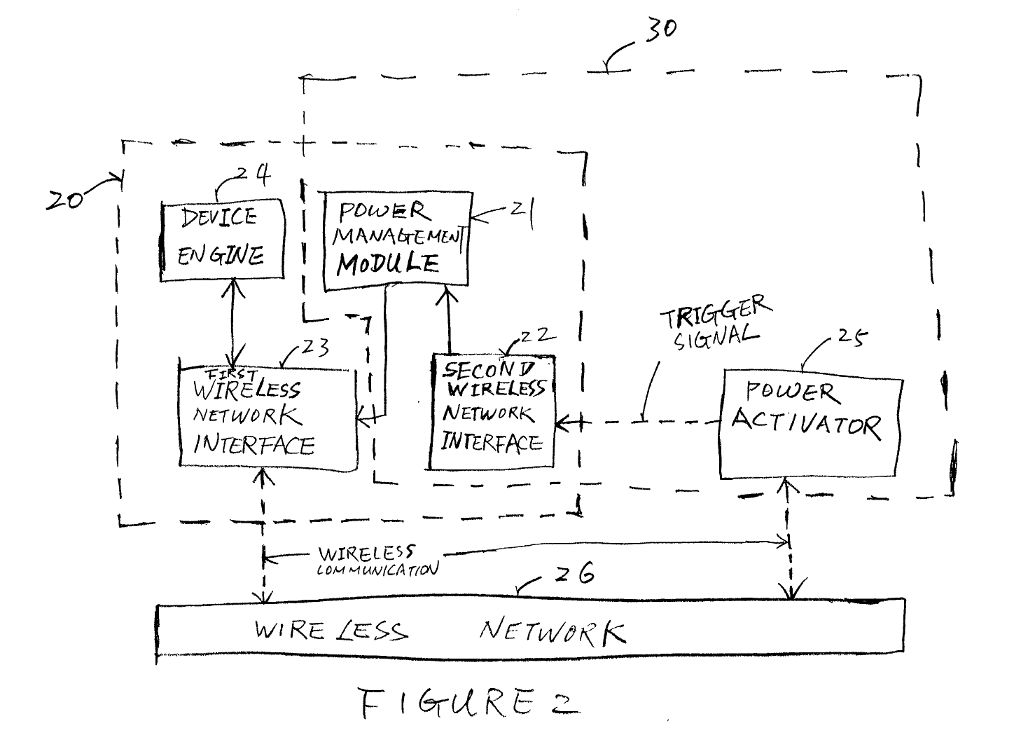

FIG. 2 shows a power management system 30 for an electronic device (e.g., the device 20). In accordance with one embodiment of the present invention, the power management system 30 reduces power consumption of a wireless communication or network interface (i.e., the network interface 23) of the device 20 while minimizing the connection latency of the interface.

As will be described in more detail below, the power management system 30 allows for power conservation of the device 20 while minimizing the connection latency of the device 20. It improves user experience in a mobile computing environment if the device is a mobile wireless communication device.

The power management system 30 achieves the above by having a power management module 21 inside the device 20 to power off the network interface 23 when the power management module 21 determines that the network interface 23 is no longer needed The power management system 30 also employs a second communication or network interface 22 in the device 20 to receive a power-up trigger signal from a power activator 25 external to the device 20. The external power activator 25 generates and sends the power-up trigger signal when an external wireless network 26 needs or requests to be connected with the device 20 via the network interface 23. The second network interface 22 passes the power-up trigger signal to the power management module 21 when the second network interface 22 receives the power-up trigger signal. The power management module 21 then causes the first network interface 23 to be powered up.

The main advantage of the power management system 30 is that it minimizes the connection latency while conserving the power consumption of the wireless device 20. The shortened connection latency of the device 20 in turn improves the user experience. In addition, the scheme implemented by the power management system 30 makes the connection to the device 20 possible if the device 20 does not have any mechanism to periodically check incoming connection requests when its network interface 23 is powered off. The power management system 30 will be described in more detail below, also in conjunction with FIGS. 2-4.

In FIG. 2, the device 20 can be any kind of portable or mobile electronic device. In one embodiment, the device 20 is a pager or a watch. In another embodiment, the device 20 is a cellular phone or satellite phone. In a further embodiment, the device 20 is a palm-top computer, a personal digital assistant, a personal organizer (e.g., the Jornada personal organizer available from Hewlett-Packard Company of Palo Alto, Calif.), or a mobile computer. In a still further embodiment, the device 20 can be a computer system. Alternatively, the device 20 can be any kind of information appliance, mobile computer system, or any kind of small portable handheld electronic device or appliance.

The device includes a device engine 24 in addition to the wireless communication or network interface 23. Both components reside inside the device 20. The device engine 24 is used to perform the main function of the device 20. Thus, the structure of the device engine 24 depends on the type of the device 20. For example, if the device 20 is a printer, then the device engine 24 is a printer system. If the device 20 is a computer, then the device engine 24 is a computer system. If the device 20 is an information appliance (e.g., Internet radio), then the device engine 24 implements that function.

The wireless network interface 23 allows the device 20 to communicate with the external wireless network 26. The external wireless network 26 is external to the device 20 and, when connection established, communicates with the device 20 through the network interface 23 wirelessly. The external wireless network 26 can be a network of wireless communication systems, or a single wireless device for connection with the device 20 (i.e., peer to peer connection).

If the external network 26 is implemented by a network of connected wireless communication systems, any device/system within the network 26 may be functioning as the gateway to interface with the device 20 via the network interface 23. In this case, the establishment of communication of the device 20 with the network 26 means having the device 20 communicate with any one of the devices/systems within the network 26.

In one embodiment, the network 26 is a radio frequency communication network. In this case, the frequency can be a long range radio frequency or short range radio frequency. In another embodiment, the network 26 is a laser communication network. In a further embodiment, the network 26 is an Infra-red communication network.

Like the network 26, the wireless network interface 23 can be any known wireless network interface and can be implemented using any known technology. In one embodiment, the network interface 23 is a radio frequency communication network interface. In this case, the frequency can be a long range radio frequency or short range radio frequency. In another embodiment, the network interface 23 is a laser communication network interface. In a further embodiment, the network interface 23 is an Infra-red communication network interface.

The communication protocol used for the wireless communication between the network 26 and the network interface 23 of the device 20 can be any known communication protocol, and only depends on the communication means employed. For example, if the network 26 and the network interface 23 employ the Infra-red communication technology for the wireless communication, then the communication protocol can be an IrDA (Infrared Data Association) protocol or TCP/IP protocol.

The power management system 30 is used to manage the power consumption of the network interface 23 while minimizing the connection latency of the network interface 23. This means that the power management system 30 causes the network interface 23 to power off when the power management system 30 determines that the network interface 23 is no longer needed. There are many ways for the power management system 30 to make the determination. For example, the power management system 30 can determine that the network interface 23 is not needed by detecting that no activity has occurred in the network interface 23. As another example, the power management system 30 determines that the network interface 23 is not needed when it detects that the user of the device 20 has switched off the connection. As a further example, the power management system 30 determines that the network interface 23 is not needed when a power-off signal is received by the system 30. Moreover, the power management system 30 determines that the network interface 23 is not needed when it determines that certain time (e.g., five minutes) has passed.

Then the power management system 30 causes the network interface 23 to power up when the power management system 30 detects that an external network (e.g., the network 26) needs to establish connection and communication with the device 20 via the network interface 23. This is done by employing the power activator 25 and the second communication or network interface 22.

As can be seen from FIG. 2, the power activator 25 is located external to the device 20 and also external to the network 26. The second network interface 22 is located inside the device 20. This means that the power management system 30 includes modules inside the device 20. The power management system 30 also includes modules or systems outside the device 20. The power activator 25 communicates with the second network interface 22 wirelessly. The power activator 25 may also communicate with the network 26, either wirelessly or via wired communication channel.

The power activator 25 is used to generate the power-up trigger signal that will cause the network interface 23 of the device 20 to be powered up from its power-off state. The power activator 25 generates the power-up trigger signal whenever the network 26 wants to communicate with the device 20 via the network interface 23 of the device 20. The power activator 25 then transmits the trigger signal out.

In one embodiment, the transmission is done by the power activator 25 in the form of regular broadcast (e.g., like a beacon). In this case, the power activator 25 is typically located close to the network 26 such that when the device 20 is close to the network 26 and the network 26 wants to communicate with the device, the second network interface 22 can receive the broadcast of the power-up trigger signal. In another embodiment, the transmission is done only when the second network interface 22 has established connection with the power activator 25. In still another embodiment, the power activator 25 only sends a connection request to the second network interface 22. In this case, the second network interface 22 generates the power-up signal when it receives the connection request from the power activator 25.

When the second network interface 22 receives the power-up trigger signal, the signal is passed to the power management module 21 of the power management system 30. The power management module 21 is also located inside the device 20. The function of the power management module 21 is to power up and power off the network interface 23.

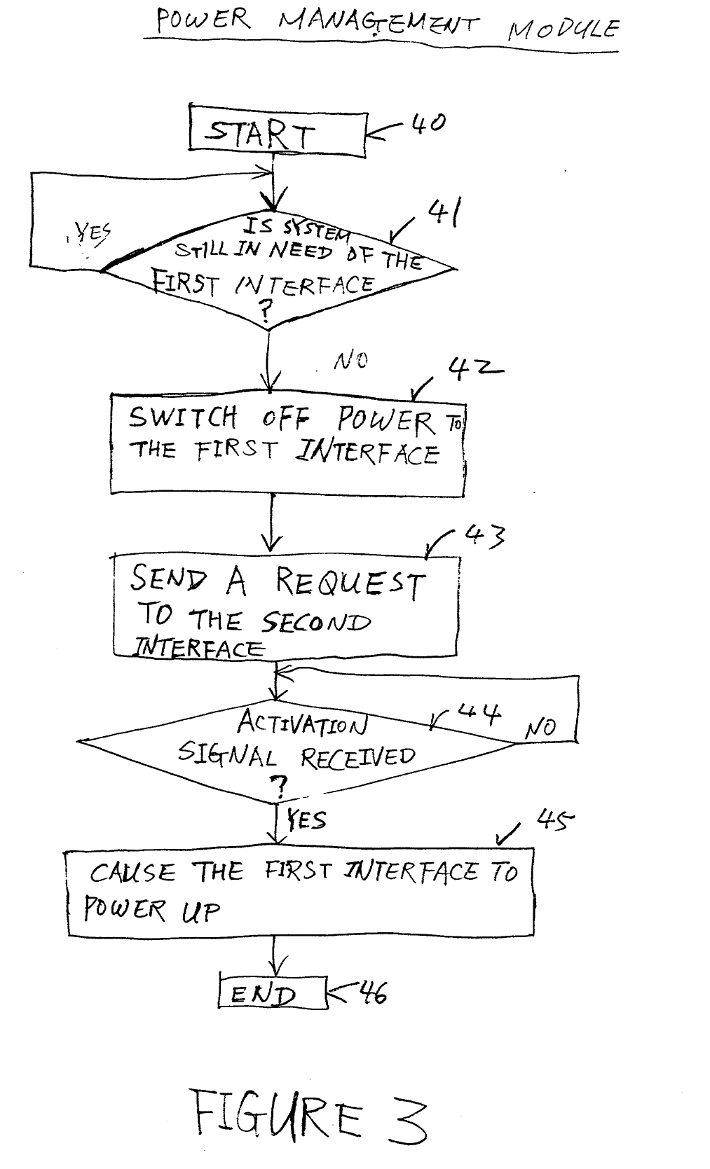

Referring back to FIG. 2, when the power management module 21 detects no activity in the network interface 23, the power management module 21 powers off the network interface 23. When the power management module 21 receives the power-up trigger signal from the second network interface 22, the power management module 21 powers up the network interface 23. The power management module 21 can be implemented using any known technology. FIG. 3 shows in more detail the process or operation of the power management module 21, which will be described in more detail below.

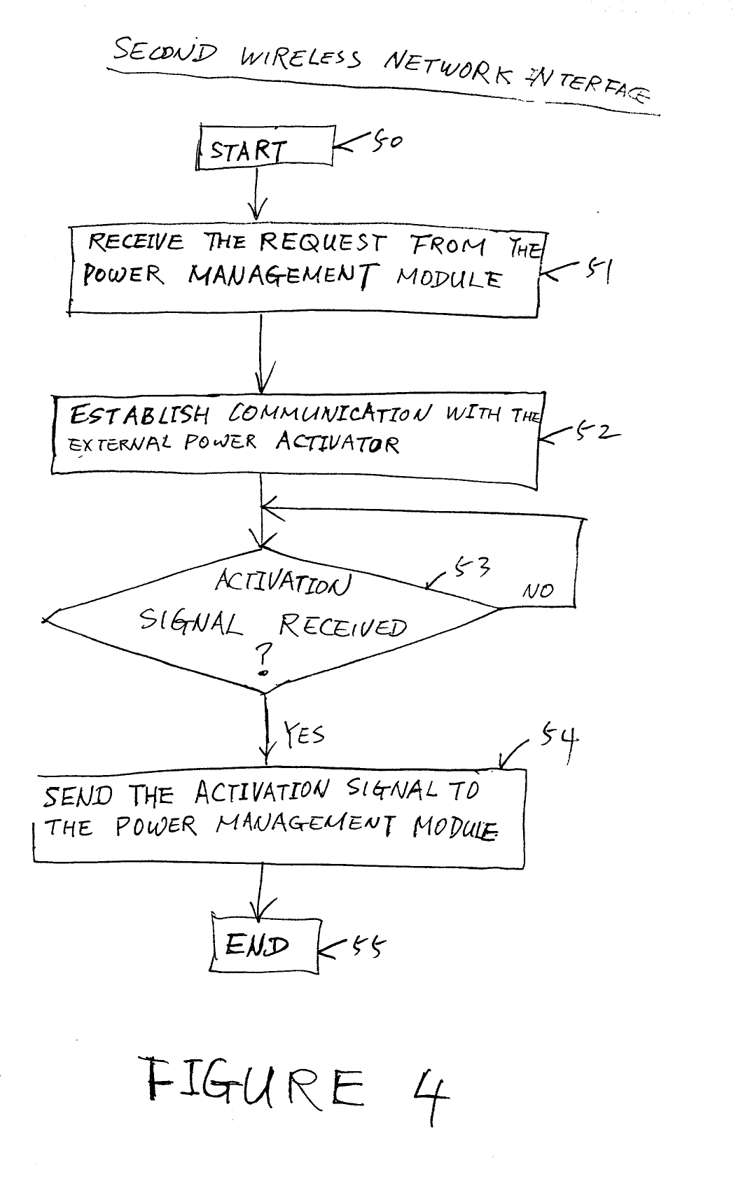

The structure of the interface 22 is substantially the same as that of the interface 23 in that both contain the physical layer, the link layer, the network layer, and the transport layer. The characteristics of the wireless network interface 22 may or may not be different from that of the wireless network interface 23. This means that the wireless network interface 22 may have shorter latency for discovering new devices and establishing communication with the newly discovered device, or a narrower discovery range. This also means less power being consumed during the discovery. This may also make the discovery process more secure. One possible pair of communication means for the two interfaces 22-23 can be (1) radio frequency for the wireless network interface 23 and (2) Infrared for the interface 22. Another pair can be that the interface 23 is a long or medium range radio frequency wireless communication interface while the interface 22 is a short range radio frequency wireless communication interface. A third possible pair can be laser for the interface 23 while infra-red for the interface 22. FIG. 4 shows in more detail the process or operation of the second network interface 22, which will be described in more detail below.

The power activator 25 can be implemented by any known technology. For example, the power activator 25 can be implemented as a beacon that passively and periodically broadcasts the trigger signal (or broadcasting according different schemes). The power activator 25 can also be a piece of software in a device (e.g., PDA) that wants to communicate with the device 20.

The power activator 25 may or may not communicate wirelessly with the network 26. In one embodiment, the power activator 25 communicates wirelessly with the network 26. In another embodiment, the power activator 25 communicates with the network 26 through wired communication channels.

Referring to FIG. 3, the process of the power management module 21 of FIG. 2 starts at the step 40. At the step 41, the power management module 21 determines whether the host device (i.e., the device 20 of FIG. 2) still needs the network interface 23. In one embodiment, this means that the power management module 21 checks to determine if any activity can be detected in the network interface 23. In another embodiment, this means that the power management module 21 detects that the user of the device 20 has switched off the connection. In still another embodiment, this means that the power management module 21 receives a power-off signal. In still a further embodiment, this means that the power management module 21 determines that certain time (e.g., five minutes) has passed.

If the answer is yes at the step 41, then the step 41 is repeated. If not, the step 42 is performed, at which the power management module 21 switches off the power supply to the network interface 23.

The power management module 21 then sends a request to the second network interface 22 at the step 43. This is to inform the second network interface 22 to pass the power-up trigger signal to the power management module 21 when the second network interface 22 receives such trigger signal. The power management module 21 then detects if any such trigger signal is received at the step 44. If the answer is no, then the step 44 is repeated. If the answer is yes, then the step 45 is performed, at which the power management module 21 causes the network interface 23 to be powered up. The process then ends at the step 46.

Referring to FIG. 4, the process of the secondary wireless network interface 22 of FIG. 2 in obtaining and passing the trigger signal is shown. The process starts at the step 50. At the step 51, the interface 22 receives the request for the power-up trigger signal from the power management module 21. At the step 52, the interface 22 establishes the communication with the external power activator 25. In one embodiment, the interface 22 achieves this by broadcasting the request. In another embodiment, the interface 22 discovers the power activator 25 and then connects to it. The discovery process can be done in known manner. For example, the IrDA protocol allows automatic discovery of new communication port in range. This means that if the interface 22 and the power activator 25 employ the IrDA infra-red (or Bluetooth short range radio) communication, the protocol will allow the power activator 25 to automatically detect the interface 22 if the interface 22 is in the communication range. Once communication is established with the interface 22, the power activator 25 sends the power-up trigger signal to the network interface 22. Alternatively, the step 52 can be skipped by the interface 22 and the interface 22 automatically receives the trigger signal from the power activator 25 when the interface 22 is close to the power activator 25.

At the step 53, the interface 22 determines whether the trigger signal has been received. If no, the step 53 is repeated. If so, the step 54 is performed. At the step 54, the interface 22 sends the trigger signal to the power management module 21 for switching on the power to the network interface 23. The process then ends at the step 55.

In the foregoing specification, the invention has been described with reference to specific embodiments thereof. It will, however, be evident to those skilled in the art that various modifications and changes may be made thereto without departing from the broader spirit and scope of the invention. The specification and drawings are, accordingly, to be regarded in an illustrative rather than a restrictive sense.

What is claimed is:

1. A system for managing power consumption of a first communication interface of a device, comprising:
a power activator external to the device to send a power-up trigger signal to the device when an external wireless network needs to communicate with the device via the first communication interface;
a second communication interface inside the device to receive the power-up trigger signal from the power activator;
a power management module coupled to the first and second communication interfaces to cause the first communication interface (1) to power off when the first communication interface is determined to be no longer needed and (2) to power up when the power management module receives the power-up trigger signal from the second communication interface.

2. The system of claim 1, wherein the power activator sends the power-up trigger signal to the second communication interface wirelessly.

3. The system of claim 1, wherein the device is a mobile device and the power activator is coupled to the external wireless network.

4. The system of claim 1, wherein the power activator is a beacon that broadcasts the power-up trigger signal when instructed by the wireless network.

5. The system of claim 1, wherein the power management module causes the first communication interface to power off when the power management module determines that the first communication interface is no longer needed.

6. The system of claim 1, wherein the first and second communication interfaces employ different wireless communication technologies.

7. The system of claim 6, wherein the second communication interface is an infrared communication interface or a short range radio communication interface, each of which can automatically discover communication partners within range.

8. The system of claim 1, wherein the power activator only sends a connection request to the second communication interface and the second communication interface then generates the power-up trigger signal.

9. The system of claim 1, wherein the power management module is located inside the device.

10. The system of claim 1, wherein the power activator is a software inside an external device that wants to communicate with the device.

11. A method for managing power consumption of a first communication interface of a device that communicates with an external wireless network, comprising:
(A) generating a power-up trigger signal from a power activator external to the device when the external wireless network needs to communicate with the device via the first communication interface;
(B) receiving the power-up trigger signal by a second communication interface inside the device;
(C) causing the first communication interface (1) to power off when the first communication interface is determined to be no longer needed and (2) to power up when the power management module receives the power-up trigger signal from the second communication interface.

12. The method of claim 11, wherein the device is a mobile device and the power activator is coupled to the external wireless network.

13. The method of claim 11, wherein the step (A) further comprising the step of broadcasting the power-up trigger signal by the power activator when instructed by the wireless network.

14. The method of claim 13, wherein the power activator is a beacon, or a software inside an external device that wants to communicate with the device.

15. The method of claim 11, wherein the step (C) further comprises the steps of
detecting any activity in the first communication interface;
if no activity is detected in the first communication interface, powering off the first communication interface;
detecting if the power-up trigger signal is received in power management module;
if the power-up trigger signal is received in the power management module, then powering up the first communication interface.

16. The method of claim 1 1, wherein the first and second communication interfaces employ different wireless communication technologies.

17. The method of claim 11, wherein the power management module is located inside the device.

18. The method of claim 11, wherein the power activator sends the power-up trigger signal to the second communication interface wirelessly.

19. The method of claim 1 1, wherein the power activator only sends a connection request to the second communication interface and then the second communication interface generates the power-up trigger signal.
